(19) United States
(12) Patent Application Publication
(10) Pub. No.: US 2025/0173104 A1
(43) Pub. Date: May 29, 2025

(54) INFORMATION PROCESSING APPARATUS, DISPLAY CONTROL METHOD, AND STORAGE MEDIUM

(71) Applicant: NEC Corporation, Tokyo (JP)

(72) Inventors: Katsuya HAYAMI, Tokyo (JP); Masaki Koizumi, Tokyo (JP); Kenta Kasahara, Tokyo (JP)

(73) Assignee: NEC Corporation, Tokyo (JP)

(21) Appl. No.: 18/948,629

(22) Filed: Nov. 15, 2024

(30) Foreign Application Priority Data
Nov. 28, 2023 (JP) 2023-200978

(51) Int. Cl. G06F 3/14

(52) U.S. Cl. CPC G06F 3/14

(57) ABSTRACT

In order to prevent deterioration in visibility in a case where a node is switched to a displayed state, an information processing apparatus includes a direction determination section that, in a case where a second node related to a first node is switched to a displayed state in a graph in which a relation between a plurality of elements is represented by nodes and an edge, determines a direction in which the second node is to be displayed relative to the first node; and a display control section that causes the second node to be displayed in the direction that has been determined. This information processing apparatus makes it possible to smoothly make a decision based on the graph.

This Nonprovisional application claims priority under 35 U.S.C. § 119 on Patent Application No. 2023-200978 filed in Japan on Nov. 28, 2023 the entire contents of which are hereby incorporated by reference.

### TECHNICAL FIELD

The present disclosure relates to an information processing apparatus, a display control method, and a storage medium.

### BACKGROUND ART

Use of a graph in which a relation between a plurality of elements is represented by nodes and an edge makes it possible to perform various analyses. For example, Patent Literature 1 below discloses a system which presents, to a user, a causal graph, in which evaluation indexes are set as nodes and a correlation between the evaluation indexes is represented by a link, and which receives a change that is made by a user on the causal graph presented. Such a system is useful in analyzing a causal relation between evaluation indexes.

Further, a covariance structure analysis is also known as an analysis method using a graph. In the covariance structure analysis, an analyst introduces a latent factor which cannot be directly observed, by analyzing a structure of covariance between observed variables which are obtained by an experiment or an observation. Then, the analyst creates a graph which represents, by nodes, the latent factors and the observed variables, and analyzes a structure of a causal relation involving the latent factors.

### CITATION LIST

### Patent Literature

[Patent Literature 1] Japanese Patent Application Publication Tokukai No. 2022-184125

### SUMMARY OF INVENTION

### Technical Problem

In the covariance structure analysis, it is preferable to allow the analyst to change a position of each of the nodes in the graph and also to allow the analyst to switch the nodes of the observed variables between a non-displayed state and a displayed state. This allows the analyst to easily find the structure of the causal relation.

However, in a case where the position of each node in the graph is changed and in addition, a node in the non-displayed state is switched to the displayed state, the node displayed may overlap on another node or an edge or may be too close to another node or an edge. This is likely to result in deterioration in visibility. This problem occurs not only in the covariance structure analysis. The problem conceivably occurs commonly in switching one or some of nodes from the non-displayed state to the displayed state in an analysis using any graph in which a relation between a plurality of elements is represented by nodes and an edge(s).

An example aspect of the present disclosure has been made in view of the above problem, and an example object thereof is to provide a technology/technique with which it is possible to prevent deterioration in visibility of a graph in a case where a node in a non-displayed state is switched to a displayed state.

### Solution to Problem

An information processing apparatus in accordance with an example aspect of the present disclosure, includes at least one processor, the at least one processor carrying out: a direction determination process of, in a case where at least one second node related to a first node is switched from a non-displayed state to a displayed state in a graph in which a relation between a plurality of elements is represented by nodes and an edge, determining a direction in which the second node is to be displayed relative to the first node; and a display control process of causing the second node to be displayed in the direction that has been determined by the direction determination process.

A display control method in accordance with an example aspect of the present disclosure includes: at least one processor carrying out a direction determination process of, in a case where at least one second node related to a first node is switched from a non-displayed state to a displayed state in a graph in which a relation between a plurality of elements is represented by nodes and an edge, determining a direction in which the second node is to be displayed relative to the first node; and the at least one processor carrying out a display control process of causing the second node to be displayed in the direction that has been determined by the direction determination process.

A storage medium in accordance with an example aspect of the present disclosure is a non-transitory, computer-readable storage medium in which a display control program is stored, the display control program causing a computer to function as: a direction determination means that, in a case where at least one second node related to a first node is switched from a non-displayed state to a displayed state in a graph in which a relation between a plurality of elements is represented by nodes and an edge, determines a direction in which the second node is to be displayed relative to the first node; and a display control means that causes the second node to be displayed in the direction that has been determined by the direction determination means.

### Advantageous Effects of Invention

An example aspect of the present disclosure yields an example advantage of making it possible to provide a technology/technique with which it is possible to prevent deterioration in visibility of a graph in a case where a node in a non-displayed state is switched to a displayed state.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of a display control method in accordance with the present disclosure.

FIG. 3 is a block diagram illustrating a configuration of another information processing apparatus in accordance with the present disclosure.

FIG. 4 is a diagram illustrating an example of switching a display state of a node by the information processing apparatus illustrated in FIG. 3.

FIG. 5 is a diagram illustrating another setting example of sectional areas.

FIG. 6 is a diagram illustrating still another setting example of sectional areas.

FIG. 7 is a diagram illustrating yet another setting example of sectional areas.

FIG. 8 is a diagram illustrating a setting example of sectional areas in accordance with a graph.

FIG. 9 is a diagram illustrating a display example in a case where a position of an expansion source node is changed beyond a boundary of a sectional area.

FIG. 10 is a flowchart illustrating a flow of a process that is carried out by the information processing apparatus illustrated in FIG. 3.

FIG. 11 is a block diagram illustrating a configuration of still another information processing apparatus in accordance with the present disclosure.

FIG. 12 is a diagram illustrating a direction of node expansion by the information processing apparatus illustrated in FIG. 3.

FIG. 13 is a diagram illustrating examples of grouping of nodes and expansion of grouped nodes.

FIG. 14 is a block diagram illustrating a configuration of a computer which functions as the information processing apparatuses in accordance with the present disclosure.

### DESCRIPTION OF EMBODIMENTS

The following description will discuss example embodiments of the present invention. Note that the present invention is not limited to the example embodiments below, but may be altered in various ways within the scope of the claims. For example, any example embodiment derived by appropriately combining technical means adopted in the example embodiments below is also within the scope of the present invention. For example, any example embodiment derived by appropriately omitting one or more of the technical means adopted in the example embodiments below is also within the scope of the present invention. An example advantage mentioned in each of the example embodiments below is an example of an advantage that is expected in that example embodiment, and is not intended to delimit the present invention. That is, any embodiment that does not provide the example advantage mentioned in the example embodiments below can also be within the scope of the present invention.

### First Example Embodiment

The following description will discuss a first example embodiment, which is an example embodiment of the present invention, in detail with reference to the drawings. The present example embodiment is basic to example embodiments described later. It should be noted that the applicable scope of each technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings which are referred to for describing the present example embodiment can be adopted in another example embodiment included in the present disclosure, to the extent of constituting no specific technical obstacle.

### (Configuration of Information Processing Apparatus 1)

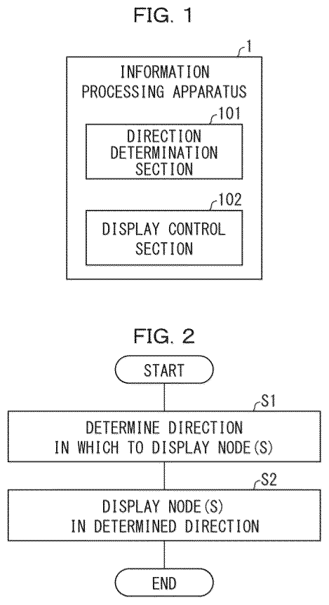

The following description will discuss a configuration of an information processing apparatus 1, with reference to FIG. 1. FIG. 1 is a block diagram illustrating the configuration of the information processing apparatus 1. The information processing apparatus 1 includes a direction determination section 101 and a display control section 102, as illustrated in FIG. 1.

In a case where in a graph in which a relation between a plurality of elements is represented by nodes and an edge(s), at least one second node related to a first node is switched from a non-displayed state to a displayed state, the direction determination section 101 determines a direction in which the second node is to be displayed relative to the first node.

Note that both of the first node and the second node are nodes constituting the above graph. Moreover, the second node only needs to be related to the first node, and may be a node that is connected to the first node or a node that is displayed in place of the first node. Timing for determining the direction may be a time point at which the second node is switched from the non-displayed state to the displayed state, or a time point before that time point (for example, a time point at which a position of each node in the graph is determined, a time point at which changing the position of the node is finished, or the like).

Further, the “graph” only needs to represent a relation between a plurality of elements by nodes and an edge(s). For example, the “graph” may be a directed graph including a directed edge or a non-directed graph including no directed edge. The directed edge may be a unidirectional edge or a bidirectional edge. Further, the “graph” may or may not include a loop. Specific examples of the “graph” include: a causal graph in which a causal relation between elements is represented by nodes and an edge(s); and a “knowledge graph” in which various pieces of knowledge and a relation thereof are represented by nodes and an edge(s). The “node(s)” here can be read as a “joint”, a “vertex”, or a “dot”. Further, the “edge(s)” can be read as a “branch(es)”, a “side(s)”, a “link(s)”, or a “line(s)”.

The display control section 102 causes the second node to be displayed in the direction that has been determined by the direction determination section 101. Note that a display apparatus for displaying the graph is optional, and can be included in the information processing apparatus 1 or in another apparatus.

As described above, the information processing apparatus 1 includes: the direction determination section 101 that, in a case where at least one second node related to a first node is switched from a non-displayed state to a displayed state in a graph in which a relation between a plurality of elements is represented by nodes and an edge, determines a direction in which the second node is to be displayed relative to the first node; and the display control section 102 that causes the second node to be displayed in the direction that has been determined by the direction determination section 101. This allows the information processing apparatus 1 to yield an example advantage of being capable of preventing deterioration in visibility of a graph in a case where the second node in the non-displayed state is switched to the displayed state.

### (Display Control Program)

The functions of the information processing apparatus 1 above can be realized by a program. A display control program in accordance with the present example embodiment causes a computer to function as: a direction determination means that, in a case where at least one second node related to a first node is switched from a non-displayed state to a displayed state in a graph in which a relation between a plurality of elements is represented by nodes and an edge, determines a direction in which the second node is to be displayed relative to the first node; and a display control means that causes the second node to be displayed in the direction that has been determined by the direction determination means. This allows the display control program to yield an example advantage of making r it possible to prevent deterioration in visibility of a graph in a case where the second node in the non-displayed state is switched to the displayed state.

### (Flow of Display Control Method)

The following description will discuss a flow of a display control method with reference to FIG. 2. FIG. 2 is a flowchart illustrating a flow of the display control method. Note that steps of the display control method may be carried out by a processor of the information processing apparatus 1 or by a processor of another apparatus. Alternatively, the steps may be carried out by processors provided in respective different apparatuses.

In S1 (direction determination process), in a case where in a graph in which a relation between a plurality of elements is represented by nodes and an edge, at least one second node related to a first node is switched from a non-displayed state to a displayed state, one or more processors determine a direction in which the second node is to be displayed relative to the first node.

In S2 (display control process), the one or more processors cause the second node to be displayed in the direction that has been determined by the direction determination process in S1.

As described above, in the display control method, the one or more processors carry out: a direction determination process of, in a case where at least one second node related to a first node is switched from a non-displayed state to a displayed state in a graph in which a relation between a plurality of elements is represented by nodes and an edge, determining a direction in which the second node is to be displayed relative to the first node; and a display control process of causing the second node to be displayed in the direction that has been determined by the direction determination process. Accordingly, the display control method can yield an example advantage of making it possible to prevent deterioration in visibility of a graph in a case where the second node in the non-displayed state is switched to the displayed state.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicable scope of each technical means adopted in the present example embodiment is not limited to the present example embodiment. That is, each technical means adopted in the present example embodiment can be adopted in another example embodiment included in the present disclosure, to the extent of constituting no specific technical obstacle. Further, each technical means illustrated in the drawings which are referred to for describing the present example embodiment can be adopted in another example embodiment included in the present disclosure, to the extent of constituting no specific technical obstacle. These matters hold true for a third example embodiment which will be described later.

### (Configuration of Information Processing Apparatus 1A)

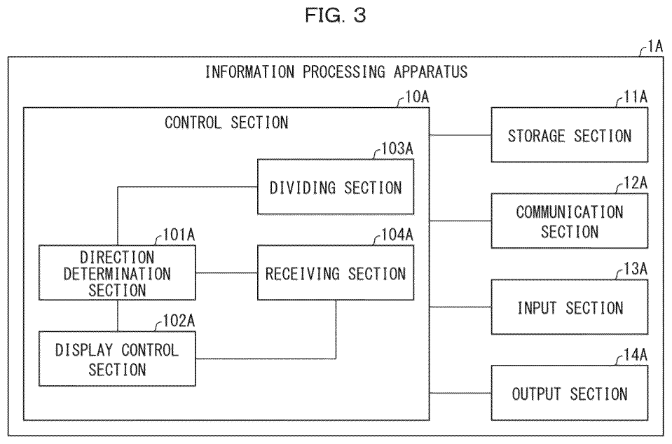

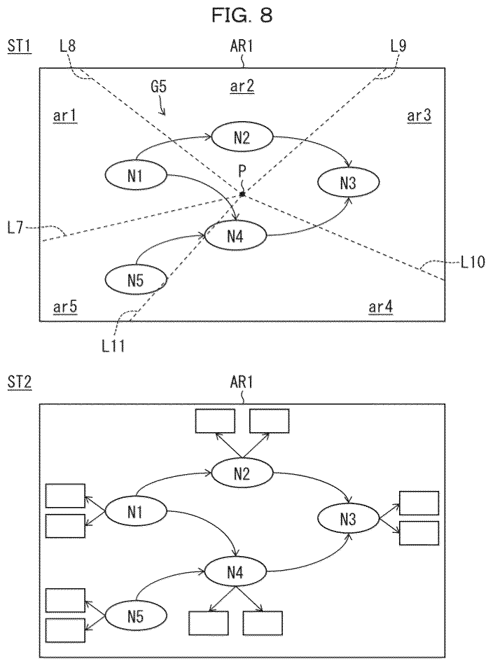

The following description will discuss a configuration of an information processing apparatus 1A, with reference to FIG. 3. FIG. 3 is a block diagram illustrating the configuration of the information processing apparatus 1A. The information processing apparatus 1A includes, as illustrated in FIG. 3: a control section 10A for performing overall control of sections of the information processing apparatus 1A; and a storage section 11A for storing various kinds of data to be used by the information processing apparatus 1A. In addition, the information processing apparatus 1A includes: a communication section 12A via which the information processing apparatus 1A communicates with another apparatus; an input section 13A for receiving an input, to the information processing apparatus 1A, of various kinds of data; and an output section 14A via which the information processing apparatus 1A outputs various kinds of data. Further, the control section 10A of the information processing apparatus 1A includes, as illustrated, a direction determination section 101A, a display control section 102A, a dividing section 103A, and a receiving section 104A. Note that the dividing section 103A will be described later with reference to FIG. 8.

In a case where in a graph in which a relation between a plurality of elements is represented by nodes and an edge(s), at least one second node related to a first node is switched from a non-displayed state to a displayed state, the direction determination section 101A determines a direction in which the second node is to be displayed relative to the first node, similarly to the direction determination section 101 provided in the information processing apparatus 1 of the first example embodiment.

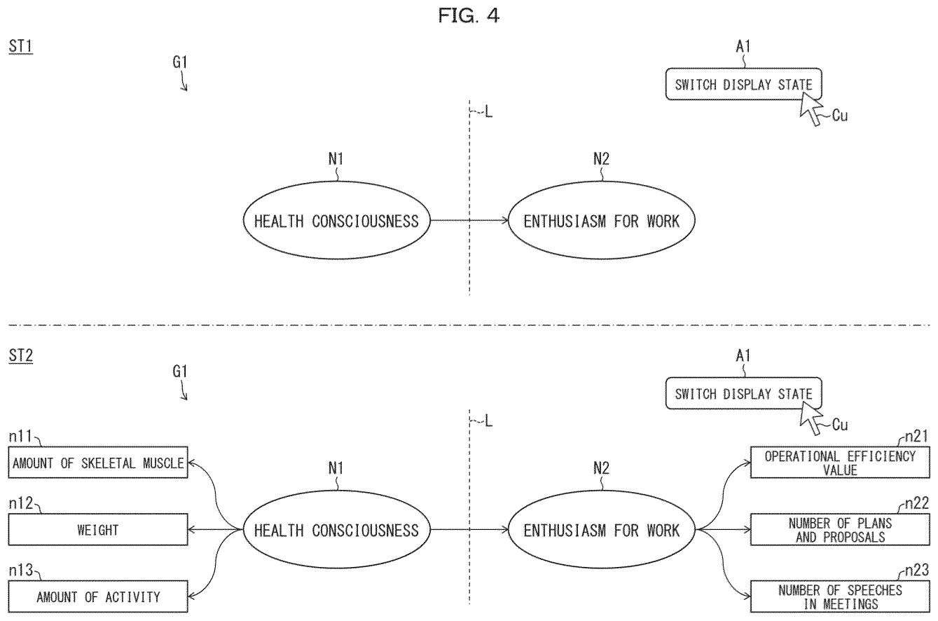

The display control section 102A causes the second node to be displayed in the direction that has been determined by the direction determination section 101A, similarly to the display control section 102 provided in the information processing apparatus 1 of the first example embodiment. Details of a method for determining the direction, which is carried out by the direction determination section 101A, and details of display control, which is carried out by the display control section 102A, will be described later with reference to FIGS. 4 to 7.

The receiving section 104A receives various operations made by a user of the information processing apparatus 1A. For example, the receiving section 104A receives an operation for switching a display state of a node or an operation for changing a position of a node.

### Example 1 of Switching Display State of Node

FIG. 4 is a diagram illustrating an example of switching the display state of a node by the information processing apparatus 1A. In the example of FIG. 4, the display control section 102A causes a graph G1, in which nodes N1 and N2 are connected to each other by an edge, to be displayed (ST1). The node N1 indicates a latent variable derived from a plurality of observed variables. Similarly, the node N2 is a node which indicates a latent variable derived from a plurality of observed variables. The edge from the node N1 to the node N2 indicates a causal relation between these latent variables. In other words, the edge indicates that “health consciousness” affects “enthusiasm for work”. In ST1, neither nodes indicating observed variables corresponding to the node N1 nor nodes indicating observed variables corresponding to the node N2 are displayed.

Presenting the graph G1 to a user can make the user recognize importance of healthcare and provide a motivation for healthcare activity. In other words, the information processing apparatus 1A can be used for promoting healthcare. Note that the information processing apparatus 1A can be used in various applications in addition to healthcare promotion.

Further, the display control section 102A also causes an object A1, which is for switching the display state of a node, and a cursor Cu, which is for carrying out an operation on a displayed object, to be displayed. Note that a boundary line L shown in FIG. 4 is a reference line in determining a direction in which a node is to be displayed. The display control section 102A may or may not cause the boundary line L to be displayed, and in order to indicate this, the boundary line L is shown as a broken line in FIG. 4. In ST1, in a case where the receiving section 104A receives an operation for selecting the object A1 with use of the cursor Cu, an image which the display control section 102A causes to be displayed is shifted to ST2.

In ST2, nodes n11 to n13 connected to the node N1 are displayed, and nodes n21 to n23 connected to the node N2 are also displayed. The nodes n11 to n13 connected to the node N1 indicate, respectively, observed variables from which the latent variable “health consciousness” has been derived. Similarly, the nodes n21 to n23 connected to the node N2 indicate, respectively, observed variables from which the latent variable “enthusiasm for work” has been derived.

Note that in the following description, switching the node from the non-displayed state to the displayed state may be expressed as “expanding”. Further, a node which is switched from the non-displayed state to the displayed state may be referred to as a “expansion node” and a node to which the expansion node is connected may be referred to as “expansion source node”. In the example of FIG. 4, the nodes N1 and N2 are expansion source nodes, and the nodes n11 to n13 and n21 to n23 are expansion nodes.

Here, the nodes n11 to n13 are expanded on the left side of the node N1, while the nodes n21 to n23 are expanded on the right side of the node N2. Expansion direction of these nodes are determined by the direction determination section 101A. That is, the direction determination section 101A determines that the nodes n11 to n13 related to the node N1 located on the left side of the boundary line L are to be expanded on the left side of the node N1. On the other hand, the direction determination section 101A determines that the nodes n21 to n23 related to the node N2 located on the right side of the boundary line L are to be expanded on the right of the node N2.

In this manner, in the example of FIG. 4, the direction determination section 101A determines the expansion direction of the nodes n11 to n13 on the basis of a position of the node N1. Further, the expansion direction of the nodes n11 to n13 is a direction from the node N1 to an outer side of a display area. Similarly, the direction determination section 101A determines the expansion direction of the nodes n21 to n23 on the basis of the position of the node N2. Further, the expansion direction of the nodes n21 to n23 is a direction from the node N2 to the outer side of the display area. Thus, the nodes n11 to n13 and the nodes n21 to n23 each do not overlap on each other or do not come too close to another node, and good visibility of these nodes is maintained in the ST2.

Note that the expansion source node is not limited to a node that indicates a latent variable, and the expansion node is not limited to a node that indicates an observed variable. The information processing apparatus 1A can be applied to display control in expanding any node related to any expansion source node. For example, the expansion source node may be a node that indicates a synthetic variable. In this case, the expansion node is a node that indicates an observed variable from which the synthetic variable has been derived.

As described above, the direction determination section 101A may determine the direction in which the expansion node is to be displayed, on the basis of the position of the expansion source node in the display area of the graph G1. This provides an example advantage of making it possible to display an expansion node in an appropriate direction in accordance with the position of the expansion source node, in addition to the example advantage provided by the information processing apparatus 1.

Further, as described above, the direction determination section 101A may determine, as the direction in which the expansion node is to be displayed, the direction from the expansion source node to the outer side of the display area. This causes a positional relation between the expansion source node and the expansion node to be fixed to a relation between an inner side and the outer side of the display area. The above configuration therefore provides an example advantage of making it possible to easily recognize the relation between an expansion source node and an expansion node, in addition to the example advantage provided by the information processing apparatus 1.

In a case where display as illustrated in FIG. 4 is carried out, the direction in which the node is to be expanded may be set in advance for each of sectional areas (respective areas on the left side and the right side of the boundary line L) that are defined by dividing, with the boundary line L, the display area of the graph G1. That is, the display area of the graph G1 may be divided into a plurality of sectional areas, and a direction may be assigned to each of the sectional areas. In this case, the direction determination section 101A may determine, as the direction in which the expansion node is to be displayed, the direction assigned to a sectional area where the expansion source node is disposed among a plurality of sectional areas obtained by dividing the display area. This provides an example advantage of making it possible to expand a node(s) in an appropriate direction with a simple process, in addition to the example advantage provided by the information processing apparatus 1.

Specifically, in the example of FIG. 4, the expansion direction associated with an area on the left side of the boundary line L may be set to a left side, and the expansion direction associated with an area on the right side of the boundary line L may be set to a right side. This allows the direction determination section 101A to determines that the direction in which the nodes n11 to n13 are to be displayed is on the left side of the node N1, and that the direction in which the nodes n21 to n23 are to be displayed is on the left side of the node N2. Further, the expansion direction set in the above-described manner in each of the sectional areas is always a direction toward the outer side of the display area. This allows the direction determination section 101A to determine, for the node N1, that the expansion direction is a direction from the node N1 to the outer side of the display area, and to determine, for the node N2, that the expansion direction is a direction from the node N2 to the outer side of the display area.

Note that in a case where the receiving section 104A receives an operation for selecting the object A1 with use of the cursor Cu in ST2, the image which the display control section 102A causes to be displayed returns to ST1. Note that it is not necessary to switch respective display states of the nodes n11 to n13 and n21 to n23 all together, but the display states may be switched individually and separately from each other.

### Another Setting Example 1 of Setting Sectional Areas

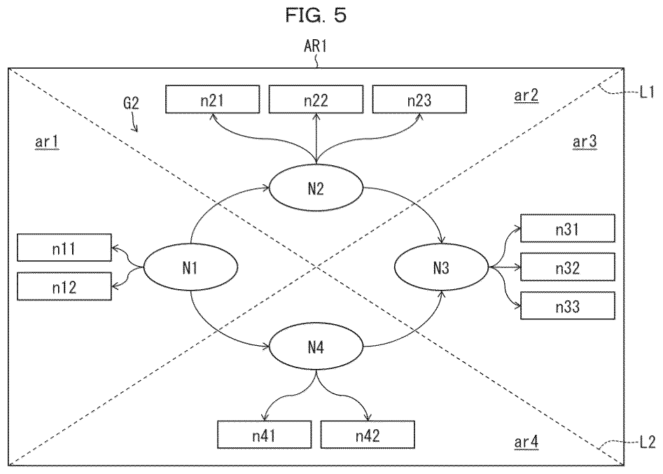

In the example of FIG. 4, two sectional areas are set by bisecting the display area of the graph G1 into left and right areas, but the sectional areas can be arbitrarily set. For example, four sectional areas may be set as illustrated in FIG. 5. FIG. 5 is a diagram illustrating another setting example of the sectional areas. In the example of FIG. 5, a display area AR1 of a graph G2 is divided by boundary lines L1 and L2, so that sectional areas ar1 to ar4 are set. Note that nodes N1 to N4 included in the graph G2 are nodes which indicate latent variables. Further, nodes n11 and n12, n21 to n23, n31 to n33, and n41 and n42 are nodes that indicate observed variables corresponding to the nodes N1 to N4. Each node indicating a latent variable is an expansion source node, and each node indicating an observed variable is an expansion node. FIG. 5 shows a state in which each of the nodes indicating the observed variables are expanded.

The display area AR1 is a rectangular area, and the boundary lines L1 and L2 are diagonals thereof. The sectional areas ar1 to ar4 thus are triangular areas that extends leftward, upward, rightward, and downward, respectively, from a center of the display area AR1. The sectional areas ar1 to ar4 are set to have respective expansion directions, which are a leftward direction, an upward direction, a rightward direction, and a downward direction, respectively. This allows the direction determination section 101A to determine that the expansion direction of the nodes n11 and n12 that are connected to the node N1 disposed in the sectional area ar1 is the leftward direction. Similarly, the direction determination section 101A can determine that the expansion direction of the nodes n21 to n23 is the upward direction, the expansion direction of the nodes n31 to n33 is the rightward direction, and the expansion directions of the nodes n41 and n42 are the downward direction.

It is possible to sufficiently ensure a display area for each expansion node, by setting the sectional areas which become wider from the center to the outer side of the display area and setting the expansion direction in each of the sectional areas to the direction from the center to the outer side of the display area, as in the example of FIG. 5. Therefore, such settings are preferable. Further, by setting such sectional areas, nodes indicating latent variables whose degree of importance is high in the graph G2 are displayed together in the vicinity of the center of the display area. Further, on the outer side of these nodes indicating latent variables, nodes indicating the observed variables are displayed. This makes it possible to easily and intuitively recognize the content of the graph G2.

### Still Another Setting Example 2 of Sectional Areas

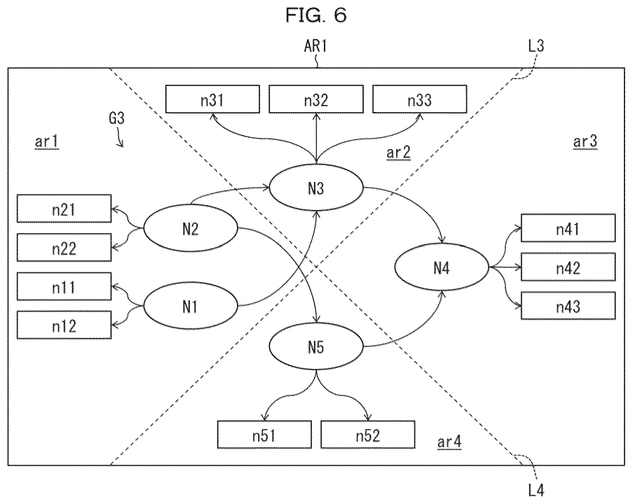

FIG. 6 is a diagram illustrating still another setting example of sectional areas. In the example of FIG. 6, a display area AR1 of a graph G3 is divided by boundary lines L3 and L4, so that sectional areas ar1 to ar4 are set.

The boundary lines L3 and L4 intersect with each other at the center or in the vicinity of the center of the display area AR1 which is rectangular, but are set in positions deviated from the diagonals. Accordingly, although the sectional areas ar2 and ar4 have a triangular shape, the sectional areas ar1 and ar3 have a pentagonal shape. Further, the sectional areas ar1 and ar3 is wider than the sectional areas ar2 and ar4. Accordingly, setting of the sectional areas in FIG. 6 is effective in the following cases: a case where there are many expansion source nodes in the sectional areas ar1 and ar3; and a case where there are many expansion nodes of those expansion source nodes. The position and the number of boundary lines may be set by the dividing section 103A, which will be described later, or may be set by a user.

### Yet Another Setting Example 3 of Sectional Areas

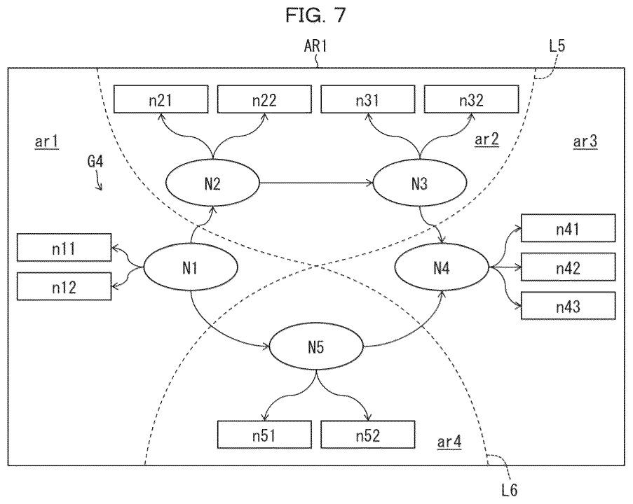

FIG. 7 is a diagram illustrating yet another setting example of sectional areas. In the example of FIG. 7, a display area AR1 of a graph G4 is divided by boundary lines L5 and L6, which are curved lines, so that sectional areas ar1 to ar4 are set. In this manner, the boundary lines that define the sectional areas may be curved lines. In a case where the boundary lines that defines the sectional areas are curves, it is possible to cause each expansion source node to belong to an appropriate sectional area. Note that a shape of the boundary lines may also be set by the dividing section 103A, which will be described later, or may be set by a user, similarly to the position and the number of the boundary lines.

### (Setting Example of Sectional Areas by Dividing Section 103A)

The dividing section 103A divides a display area in accordance with a graph and sets a plurality of sectional areas. The dividing section 103A is not an essential configuration. However, the information processing apparatus 1A including the dividing section 103A provides an example advantage of making it possible to expand a node(s) in an appropriate expansion direction(s) by setting appropriate sectional areas in accordance with a graph, in addition to the example advantage provided by the information processing apparatus 1.

A method for setting the sectional areas by the dividing section 103A is not particularly limited, provided that a node(s) can be expanded by the method so as to have good visibility in each of the sectional areas set. For example, the dividing section 103A may set the sectional areas by assigning a sectional area to each of the expansion source nodes.

This will be described below with reference to FIG. 8. FIG. 8 is a diagram illustrating a setting example of sectional areas in accordance with a graph. In the example of FIG. 8, a graph G5 including nodes N1 to N5 each indicating a latent variable is displayed in a display area AR1. In ST1 of FIG. 8, a setting example of sectional areas by the dividing section 103A is illustrated, and in ST2 of FIG. 8, an example of expansion of nodes with use of the sectional areas set is illustrated. Note that in ST1, all of the nodes of observed variables that are connected to the nodes N1 to N5 are in the non-displayed state.

In ST1, the dividing section 103A sets boundary lines L7 to L11 whose starting point is a point P serving as a center of the display area AR1. The dividing section 103A thus assigns respective sectional areas ar1 to ar5 to the nodes N1 to N5. For example, the dividing section 103A may set, to the boundary line L7, a segment that is equidistant from a center of the node N1 and a center of the node N5 and that reaches, from the point P, an outer edge of the display area AR1. Similarly, the dividing section 103A can set: the boundary line L8 that separates the nodes N1 and N2 from each other; the boundary line L9 that separates the nodes N2 and N3 from each other; the boundary line L10 that separates the nodes N3 and N4 from each other; and the boundary line L11 that separates the nodes N4 and N5 from each other. Note that in the example of FIG. 8, all of the boundary lines L7 to L11 are drawn as straight lines, but some or all of the boundary lines may be curved lines.

Further, the expansion direction of the node(s) in each of the sectional areas may be also set by the dividing section 103A. For example, in a case where one side of a sectional area set constitutes the outer edge of the display area AR1, the dividing section 103A may set, as the expansion direction, a direction from the center P of the display area AR1 to the one side. For example, the dividing section 103A may set the expansion direction in the sectional area ar2 to the upward direction.

Further, in a case where two sides of a sectional area set, such as the sectional areas ar1, ar3, and ar4, constitute the outer edge of the display area AR1, the dividing section 103A may set, as the expansion direction, a direction from the center P of the display area AR1 to a longer one of the two sides. For example, the dividing section 103A may set expansion directions of the sectional areas ar1, ar3, and ar4 to the leftward direction, the rightward direction, and the downward direction, respectively.

Note that in a case where a sectional area set, such as the sectional area ar5, has two sides that constitute the outer edge of the display area AR1 and that have no large difference in length, the dividing section 103A may set, as the expansion direction, a direction toward one of the two sides of the sectional area or a direction toward an intersection of the two sides of the sectional area. For example, the dividing section 103A may set the expansion direction of the sectional area ar5 to the leftward direction, the downward direction, or a left-downward direction.

Setting the sectional areas ar1 to ar5 illustrated in ST1 of FIG. 8, as illustrated in ST2 of FIG. 8, makes it possible to display, with good visibility, each node expanded from each of the nodes N1 to N5.

Note that in the example of FIG. 8, one sectional area is set so as to correspond to one expansion source node, but the dividing section 103A may assign one sectional area to a plurality of expansion source nodes. Further, the dividing section 103A may set the sectional areas such that the number of the expansion source nodes that belong to one sectional area is not more than a predetermined upper limit. For example, in the example of FIG. 8, in a case where the upper limit is two, the dividing section 103A may set a sectional area from the boundary lines L10 to L7 (a combined area of the sectional areas ar4 and ar5) as a sectional area which is assigned to the nodes N4 and N5. Note that the upper limit may be a fixed value, or may be set by the dividing section 103A in accordance with, for example, the number of expansion source nodes which are included in a graph.

Further, in a case where a size or a shape of the display area AR1 is changed or in a case where the receiving section 104A receives an operation for changing the position of the node, the dividing section 103A may rearrange the sectional areas on the basis of the display area AR1 and/or the position of the node after such a change.

### (Process for Changing Positions of Nodes)

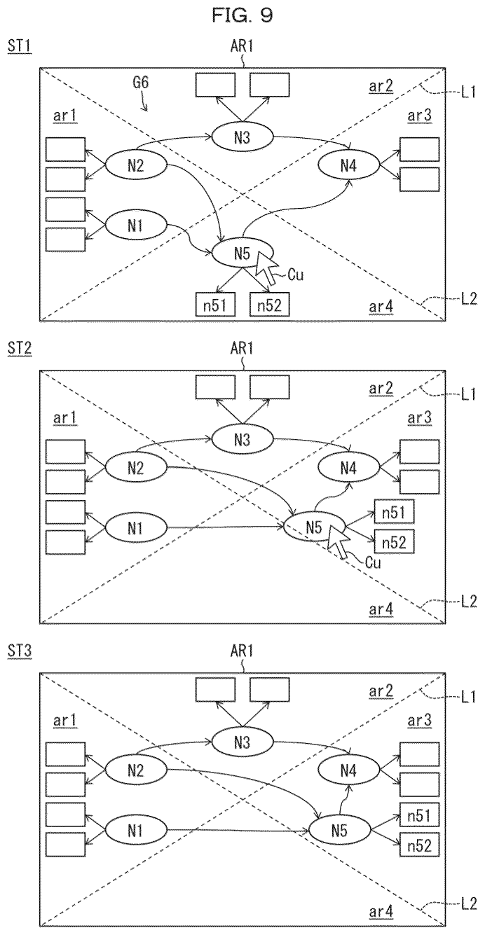

In a case where the position of an expansion source node of nodes is changed beyond a boundary of a sectional area in a state in which the nodes are expanded, a direction in which those expansion nodes are to be displayed may be changed in accordance with such a change in the position of the expansion source node without rearranging sectional areas. This will be described below with reference to FIG. 9. FIG. 9 is a diagram illustrating a display example in a case where the position of an expansion source node is changed beyond the boundary of a sectional area.

In the example of FIG. 9, a graph G6 including nodes N1 to N5 of latent variables is displayed in a display area AR1. Also, nodes of observed variables corresponding to the nodes N1 to N5 are in a displayed state. In addition, the display area AR1 is divided into sectional areas ar1 to ar4 by boundary lines L1 and L2.

In ST1 of FIG. 9, the node N5 is selected with use of the cursor Cu. At this time point, the node N5 is located in the sectional area ar4. Further, nodes n51 and n52, which are connected to the node N5, are displayed on a lower side of the node N5. This is because the expansion direction of the sectional area ar4 is set to the downward direction.

In ST2 of FIG. 9, the node N5 is moved to the sectional area ar3 with use of the cursor Cu. For example, the receiving section 104A may receive an operation for selecting and dragging the node N5, as an operation for changing the position of the node N5.

An expansion direction of the sectional area ar3 here is set to the rightward direction. Accordingly, in ST2, the display positions of the nodes n51 and n52, which are connected to the node N5, are changed to a position on the right side of the node N5. In the case of such a display, the direction determination section 101A determines the direction in which the nodes n51 and n52 are to be displayed, at each position of the node N5 during change in the position of the node N5. Then, the display control section 102A causes the nodes n51 and n52 to be displayed in the direction determined.

In ST3, the operation for changing the position of the node N5 ends, and the position of the node N5 is fixed in the sectional area ar3. In ST3, the nodes n51 and n52 are displayed at positions on the right side of the node N5, as in ST2.

As described above, the information processing apparatus 1A may include the receiving section 104A that receives an operation for changing the position of a node. Then, in a case where the position of an expansion source node is changed while an expansion node(s) is/are in the displayed state, the display control section 102A may change, in accordance with the change in the position, the direction in which the expanded node(s) is/are to be displayed. This provides an example advantage of allowing a user to check how an expanded node(s) is/are displayed in accordance with movement of an expansion source node, and to determine an optimum position(s), in addition to the example advantage provided by the information processing apparatus 1.

### (Flow of Processes)

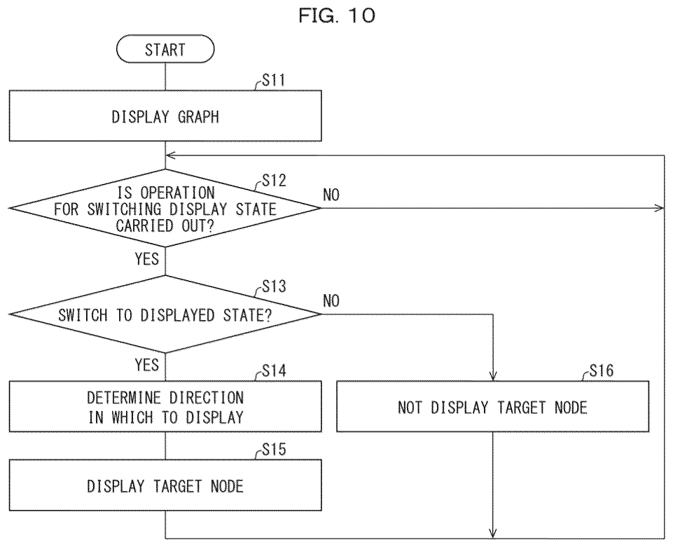

The following description will discuss a flow of processes carried out by the information processing apparatus 1A, with reference to of FIG. 10. FIG. 10 is a flowchart illustrating a flow of the processes carried out by the information processing apparatus 1A. FIG. 10 includes processes of a display control method in the present example embodiment.

In S11, the display control section 102A causes a graph in which a relation between a plurality of elements is represented by nodes and an edge(s) to be displayed. For example, the display control section 102A may carry out the process of S11 in response to reception, by the receiving section 104A, of an operation for causing a graph to be displayed. Note that the information processing apparatus 1A may also generate a graph and/or analyze a relation between elements on which the graph is based.

In S12, the receiving section 104A determines whether or not a switching operation for switching the display state of a node in the graph displayed in S11 has been carried out. For example, the receiving section 104A may determine that a switching operation has been carried out in a case where the object A1 illustrated in FIG. 4 has been operated. In a case where a result of such determination is YES in S12, the process proceeds to S13. On the other hand, in a case where the result of the determination is NO in S12, the receiving section 104A continues to wait for a switching operation.

In S13, the receiving section 104A determines whether the switching operation detected in S12 is an operation for switching a node in the non-displayed state to the displayed state. In a case where a result of such determination is YES in S13, the process proceeds to S14. In a case where the result of the determination is NO in S13, that is, in a case where the switching operation detected in S12 is an operation for switching the node in the displayed state to the non-displayed state, the process proceeds to S16. In S16, the display control section 102A changes, to the non-display state, the node which is a target of the switching operation and the edge which is connected to the node. Then, the process returns to S12.

In S14 (the direction determination process), the direction determination section 101A determines a direction in which the expansion node is to be displayed relative to the expansion source node. In other words, the direction determination section 101A determines the expansion direction. For example, the direction determination section 101A may determine which one of a plurality of sectional areas, into which the display area of the graph is divided, the expansion source node is located in. The direction determination section 101A may then determine, as the expansion direction, the direction assigned to the sectional area in which the expansion source node is located.

Although not illustrated in FIG. 10, before carrying out the process of S14, the dividing section 103A may set a plurality of sectional areas by dividing the display area in accordance with the graph displayed in S11. Further, the dividing section 103A may assign, to each of the sectional areas thus set, an expansion direction of a node(s). In this case, in S14, the direction determination section 101A determines which one of the sectional areas, which have been set by the dividing section 103A, the expansion source node is disposed in.

In S15 (display control process), the display control section 102A causes a target node, i.e., an expansion node, to be displayed in the direction determined in S14. Thereafter, the process returns to S12.

### Third Example Embodiment

### (Configuration of Information Processing Apparatus 1B)

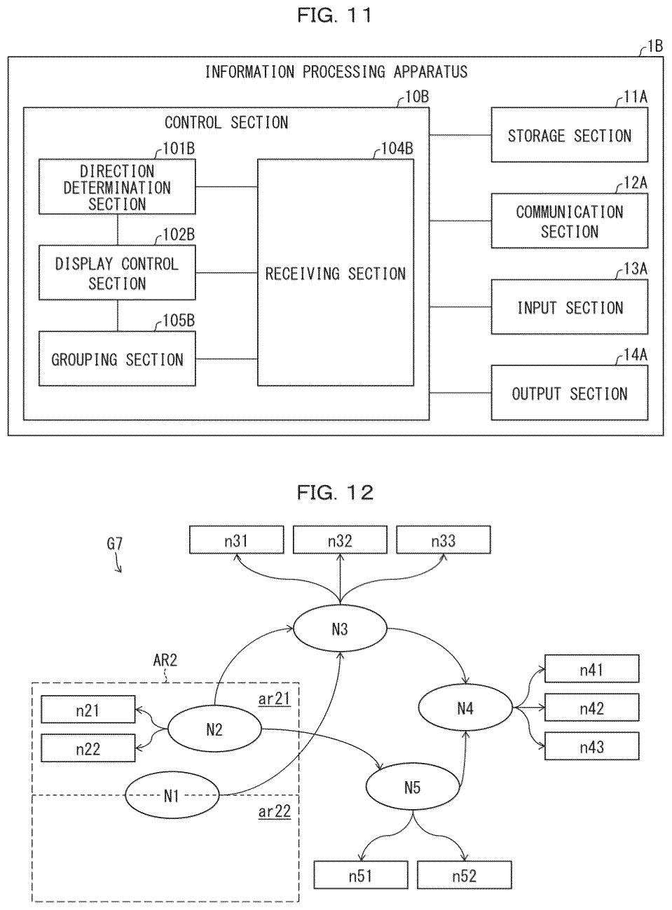

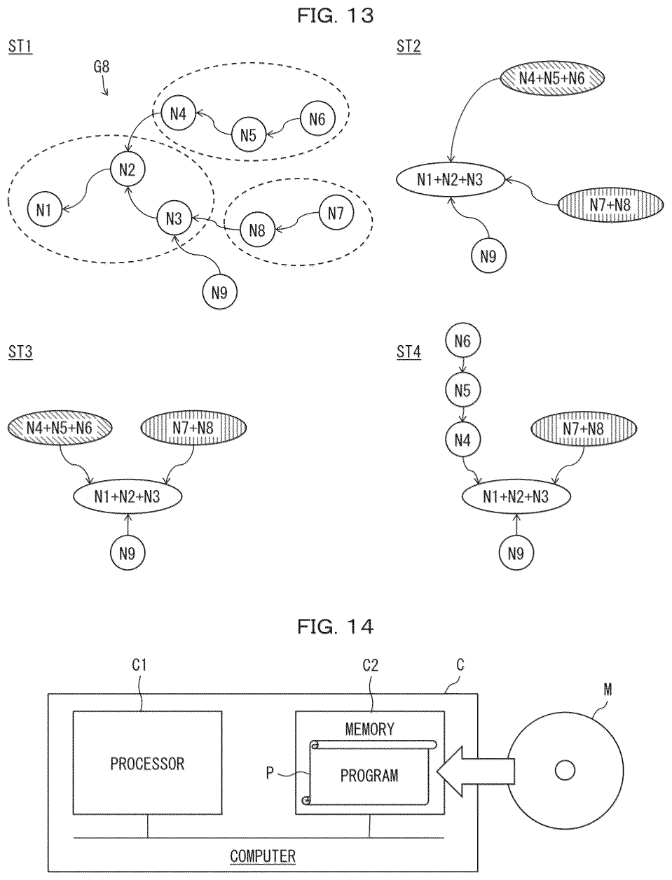

The following description will discuss a configuration of an information processing apparatus 1B, with reference to FIG. 11. FIG. 11 is a block diagram illustrating the configuration of the information processing apparatus 1B. The information processing apparatus 1B includes a control section 10B for performing overall of control sections of the information processing apparatus 1B, as illustrated in FIG. 11. The control section 10B includes a direction determination section 101B, a display control section 102B, a receiving section 104B, and a grouping section 105B. Note that a flow of processes carried out by the information processing apparatus 1B is the same as the flow of the processes in the second example embodiment illustrated in FIG. 10. The grouping section 105B will be described later with reference to FIG. 13.

In a case where in a graph in which a relation between a plurality of elements is represented by nodes and an edge(s), at least one second node related to a first node is switched from a non-displayed state to a displayed state, the direction determination section 101B determines a direction in which the second node is to be displayed relative to the first node, similarly to the direction determination section 101 provided in the information processing apparatus 1 of the first example embodiment. A method for determining an expansion direction by the direction determination section 101B will be described later with reference to FIG. 12.

The display control section 102B causes the second node to be displayed in the direction that has been determined by the direction determination section 101B, similarly to the display control section 102 provided in the information processing apparatus 1 of the first example embodiment.

The receiving section 104B receives various operations carried out by a user of the information processing apparatus 1B, similarly to the receiving section 104A provided in the information processing apparatus 1A of the second example embodiment. For example, the receiving section 104B may receive an operation for changing a position(s) of a node(s). Further, in a case where the receiving section 104B receives an operation for changing the position of an expansion source node in a state in which a node(s) is/are expanded from the expansion source node, the direction determination section 101B may determine an expansion direction at each position of the expansion source node during change in the position of the expansion source node. This makes it possible for the display control section 102B to change, in accordance with the change in the position, the direction in which the node that is expanded is displayed.

### (Method for Determining Expansion Direction)

The following description will discuss a method for determining the expansion direction of a node by the direction determination section 101B, with reference to FIG. 12. FIG. 12 is a diagram illustrating an expansion direction of a node(s). FIG. 12 shows a graph G7 which includes nodes N1 to N5 corresponding to latent variables. A node of an observed variable corresponding to the node N1 is not displayed, but all of nodes (n21 to n52) of observed variables corresponding to the nodes N2 to N5 are displayed.

In a case where the node of the observed variable corresponding to the node N1 is to be displayed, the direction determination section 101B divides, into a plurality of sectional surrounding areas, a surrounding area of the node N1. In an example illustrated in FIG. 12, the direction determination section 101B bisects, into top and bottom sectional surrounding areas, a rectangular area AR2 centered on the node N1, and defines sectional surrounding areas ar21 and ar22. The rectangular area AR2 may have a size whose value is fixed, or the direction determination section 101B may set a rectangular area having a size corresponding to, for example, the number of expansion nodes.

Next, the direction determination section 101B counts the number of nodes disposed in each of the sectional surrounding areas. In the example of FIG. 12, the number of nodes disposed in the sectional surrounding area ar21 is 3, and the number of nodes disposed in the sectional surrounding area ar22 is zero. Note that it is not necessary to count the node N1 itself.

The direction determination section 101B then identifies a sectional surrounding area having the smallest number of nodes disposed therein, and determines, as a direction in which the expansion nodes are to be displayed, a direction in which the sectional surrounding area is disposed. In the example of FIG. 12, the direction determination section 101B determines, as the direction in which the expansion nodes are to be displayed, a direction in which the sectional surrounding area ar22 is located, i.e., the lower side of the node N1.

Note that the surrounding area of the node N1 may be divided into three or more sectional surrounding areas. Note however that preferably, the sectional surrounding areas each individually have a size which is wide enough to accommodate, in that sectional surrounding area, at least the expansion nodes. Further, the direction determination section 101B may determine, as the expansion direction, a direction in which among the above plurality of sectional surrounding areas defined in the surrounding area of the node N1, a sectional surrounding area in which the number of nodes disposed in that sectional surrounding area is not more than a predetermined threshold.

Further, there may be a case where there are a plurality of sectional surrounding areas in which the number of nodes disposed therein is not more than the predetermined threshold. How to determine the expansion direction in such a case can be defined in advance. For example, it may be defined in advance that a direction in which there is a sectional surrounding area that is located in a direction toward an outer side of the display area of the graph from the expansion source node is preferentially defined as the expansion direction.

As described above, the direction determination section 101B determines the direction in which an expansion node (second node) is to be displayed, on the basis of a position of another node which is displayed in a surrounding area of an expansion source node (first node). This provides an example advantage of making it possible to expand a node(s) in an appropriate expansion direction in consideration of a position of another node(s) in a surrounding area, in addition to the example advantage provided by the information processing apparatus 1.

Note that it is also possible to combine the method for determining the expansion direction described in the second example embodiment with the method for determining the expansion direction in the present example embodiment. That is, the direction determination section 101B may determine the expansion direction of an expansion node, on the basis of both of the position of an expansion source node in a display area of a graph and the position of another node which is displayed in a surrounding area of the expansion source node.

For example, the direction determination section 101B may determine which one of a plurality of sectional areas the expansion source node is disposed in, similarly to the direction determination section 101A. Then, in a case where no other node is disposed in the direction assigned to a sectional area in which the expansion source node is disposed, the direction determination section 101B may determine that the direction is the expansion direction. On the other hand, in a case where another node is disposed in the direction, the direction determination section 101B may determine, as the expansion direction, a direction in which no other node is disposed. Alternatively, for example, the direction determination section 101B may determine, as the expansion direction, a direction in which no other node is disposed among directions from the expansion source node to the outer side of the display area of the graph.

Further, as described above, the direction determination section 101B may divide a surrounding area of the expansion source node into a plurality of sectional surrounding areas, and determine, on the basis of the number of other nodes disposed in each of the sectional surrounding areas, the direction in which the expansion node is to be displayed. This provides an example advantage of making it possible to expand a node in the most appropriate sectional surrounding area in the surrounding area of the expansion source node, in addition to the example advantage provided by the information processing apparatus 1.

### (Grouping and Expansion)

The following description will discuss grouping of nodes and expansion of grouped nodes, with reference to FIG. 13. FIG. 13 is a diagram illustrating examples of grouping of nodes and expansion of grouped nodes. The grouping of nodes is carried out by the grouping section 105B. The grouping section 105B groups a plurality of nodes which are connected to each other.

FIG. 13 illustrates graphs each including nodes N1 to N9. The receiving section 104B receives designation of nodes to be grouped. In a case where nodes to be grouped are designated, the grouping section 105B sets, in a single group, the nodes which have been designated. In ST1, the nodes N1 to N3 are designated as a single group, as illustrated by a dashed circle. Similarly, the nodes N4 to N6 are designated as a single group, and the nodes N7 and N8 are also designated as a single group. Note that the grouping section 105B may automatically group nodes related to each other.

It is possible to cause the nodes which are grouped by the grouping section 105B to be displayed as a single node (hereinafter, referred to as “alternative node”) that represents the nodes, instead of causing each node belonging to the group to be displayed. In ST2 of FIG. 13, the display control section 102B causes an alternative node that is indicated as “N1+N2+N3” to be displayed in place of the nodes N1 to N3 which have been grouped in ST1. Note that, hereinafter, this alternative node is denoted as “alternative node (N1 to N3)”. Further, other alternative nodes will be similarly denoted. Further, in ST2, the display control section 102B causes an alternative node (N4 to N6) and an alternative node (N7 and N8) to be displayed, in place of the nodes N4 to N6 and the nodes N7 to N8, respectively. In this manner, an alternative node is displayed in place of each node that belongs to a single group. This makes it possible to easily recognize a relation between the nodes.

Further, the receiving section 104B may receive an operation for changing a position(s) of an alternative node(s). This makes it possible to further facilitate recognition of the relation between the nodes. For example, the position of each of the nodes that includes an alternative node is changed as in ST3 of FIG. 13. This makes it possible to facilitate the recognition of the relation between the nodes. It should be noted, however, that in a case where after a position of an alternative node is changed, a display form of the alternative node is returned to a previous display form, nodes each corresponding to the alternative node may overlap on another node or be in close proximity to another node. This may lead to deterioration in visibility of the graph.

In light of the above, in a case where a plurality of corresponding nodes are to be displayed in place of an alternative node, i.e., each of the nodes related to the alternative node is switched from a non-displayed state to a displayed state, the direction determination section 101B may determine a direction in which each of the nodes is to be displayed relative to the alternative node. Then, the display control section 102B may cause each of the nodes to be displayed in the direction thus determined. This makes it possible to reduce possibility of deterioration in visibility of the graph in a case where the display form of an alternative node is switched. Note that in a case where display of the alternative node is returned to an original node display, it is possible to cause one or some of the nodes to be displayed at a position where the alternative node was displayed.

For example, in ST3 of FIG. 13, no other node is on an upper side of the alternative node (N1 to N3). Accordingly, in a case where display of the alternative node (N4 to N6) is returned to display of the nodes N4 to N6, the direction determining section 101B may determine that the direction in which the nodes N4 to N6 are to be displayed is the upper side of the alternative node (N1 to N3). As a result, the display control section 102B causes the node N4 among the nodes N4 to N6 that is connected to the alternative nodes (N1 to N3) to be displayed at a position where the alternative node (N4 to N6) was displayed, as illustrated in ST4 of FIG. 13. The display control section 102B also causes the nodes N5 and N6 to be displayed on the upper side of the position where the alternative node (N4 to N6) was displayed, as illustrated in ST4 of FIG. 13. It can be said that the nodes N4 to N6 displayed in ST4 do not overlap on another node or are not in close proximity to another node, and that good visibility of the graph G8 is maintained.

Note that the direction determination section 101B may determine, on the basis of the position of the alternative node in the display area of the graph G8, the expansion direction of the alternative node, as in the second example embodiment. In this case, the direction determination section 101B may determine the expansion direction, according to which one of the sectional areas set in advance the alternative node whose display form is to be changed is disposed in. Further, as in the second example embodiment, the dividing section 103A may be provided. Then, the direction determination section 101B may be configured to determine the expansion direction, according to which one of the sectional areas set by the dividing section 103A the alternative node is disposed in.

### Variations

Each of the processes described in the example embodiments above may be carried out by any subject, and the subject is not limited to the above examples. In other words, it is possible to implement the functions of the information processing apparatuses 1, 1A, and 1B with use of a plurality of apparatuses (which can be said to be processors) capable of communicating with each other. For example, the respective processes described in the flowcharts of FIGS. 2 and 10 can be split among the plurality of processors and carried out by the plurality of processors. That is, the subject that carries out the processes in the example embodiments described above may be a single processor, or may include a plurality of processors.

### Software Implementation Example

Some or all of functions of the information processing apparatus 1, 1A, and 1B can be realized by hardware such as an integrated circuit (IC chip) or the like or can be alternatively realized by software.

In the latter case, the information processing apparatus 1, 1A, or 1B is realized by, for example, a computer that executes instructions of a program that is s software realizing the foregoing functions. An example (hereinafter, referred to as “computer C”) of such a computer is illustrated in FIG. 14. FIG. 14 is a block diagram illustrating a hardware configuration of the computer C which functions as the information processing apparatus 1, 1A, or 1B.

The computer C includes at least one processor C1 and at least one memory C2. The at least one memory C2 stores a program P (display control program) for causing the computer C to operate as each of the information processing apparatuses. In the computer C, the at least one processor C1 reads and executes the program P stored in the at least one memory C2, so that the functions of the information processing apparatus 1, 1A, or 1B are realized.

Examples of the at least one processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input/output interface through which input/output equipment such as a keyboard, a mouse, a display and/or a printer is/are to be connected to the computer C.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can obtain the program P via the storage medium M. The program P can be alternatively transmitted via a transmission medium. Examples of such a transmission medium encompass a communication network and a broadcast wave. The computer C can alternatively obtain the program P via the transmission medium.

### [Additional Remark 1]

The present disclosure includes technologies/techniques described in supplementary notes below. Note, however, that example embodiments of the present invention are not limited to the technologies/techniques described in the supplementary notes below, but may be altered in various ways by a skilled person within the scope of the claims.

### (Supplementary Note A1)

An information processing apparatus including: a direction determination means that, in a case where at least one second node related to a first node is switched from a non-displayed state to a displayed state in a graph in which a relation between a plurality of elements is represented by nodes and an edge, determines a direction in which the second node is to be displayed relative to the first node; and a display control means that causes the second node to be displayed in the direction that has been determined by the direction determination means.

### (Supplementary Note A2)

The information processing apparatus according to supplementary note A1, wherein the direction determination means determines the direction in which the second node is to be displayed, on the basis of a position of the first node in a display area of the graph.

### (Supplementary Note A3)

The information processing apparatus according to supplementary note A2, wherein the direction determination means determines, as the direction in which the second node is to be displayed, a direction from the first node to an outer side of the display area.

### (Supplementary Note A4)

The information processing apparatus according to supplementary note A2 or A3, wherein the direction determination means determines, as the direction in which the second node is to be displayed, a direction assigned to a sectional area in which the first node is disposed among a plurality of sectional areas into which the display area is divided.

### (Supplementary Note A5)

The information processing apparatus according to supplementary note A4, further including a dividing means that sets the plurality of sectional areas by dividing the display area in accordance with the graph.

### (Supplementary Note A6)

The information processing apparatus according to any one of supplementary notes A1 to A5, wherein the direction determination means determines the direction in which the second node is to be displayed, on the basis of a position of another node which is displayed in a surrounding area of the first node.

### (Supplementary Note A7)

The information processing apparatus according to supplementary note A6, wherein the direction determination means divides the surrounding area of the first node into a plurality of sectional surrounding areas, and determines the direction in which the second node is to be displayed, on the basis of the number of other nodes disposed in each of the sectional surrounding areas.

### (Supplementary Note A8)

The information processing apparatus according to any one of supplementary notes A1 to A7, further including a receiving means that receives an operation for changing a position of the first node, in a case where a change in the position of the first node is made while the second node is in the displayed state, the display control means changing, in accordance with the change in the position, the direction in which the second node is to be displayed.

### (Supplementary Note B1)

A display control method including: at least one processor carrying out a direction determination process of, in a case where at least one second node related to a first node is switched from a non-displayed state to a displayed state in a graph in which a relation between a plurality of elements is represented by nodes and an edge, determining a direction in which the second node is to be displayed relative to the first node; and the at least one processor carrying out a display control process of causing the second node to be displayed in the direction that has been determined by the direction determination process.

### (Supplementary Note B2)

The display control method according to supplementary note B1, wherein in the direction determination process, the at least one processor determines the direction in which the second node is to be displayed, on the basis of a position of the first node in a display area of the graph.

### (Supplementary Note B3)

The display control method according to supplementary note B2, wherein in the direction determination process, the at least one processor determines, as the direction in which the second node is to be displayed, a direction from the first node to an outer side of the display area.

### (Supplementary Note B4)

The display control method according to supplementary note B2 or B3, wherein in the direction determination process, the at least one processor determines, as the direction in which the second node is to be displayed, a direction assigned to a sectional area in which the first node is disposed among a plurality of sectional areas into which the display area is divided.

### (Supplementary Note B5)

The display control method according to supplementary note B4, wherein the at least one processor carries out a division process of setting the plurality of sectional areas by dividing the display area in accordance with the graph.

### (Supplementary Note B6)

The display control method according to any one of supplementary notes B1 to B5, wherein in the direction determination process, the at least one processor determines the direction in which the second node is to be displayed, on the basis of a position of another node which is displayed in a surrounding area of the first node.

### (Supplementary Note B7)

The display control method according to supplementary note B6, wherein in the direction determination process, the at least one processor divides the surrounding area of the first node into a plurality of sectional surrounding areas, and determines the direction in which the second node is to be displayed, on the basis of the number of other nodes disposed in each of the sectional surrounding areas.

### (Supplementary Note B8)

The display control method according to any one of supplementary notes B1 to B7, wherein: the at least one processor carries out a reception process of receiving an operation for changing a position of the first node; and in a case where a change in the position of the first node is made while the second node is in the displayed state, the at least one processor changes, in accordance with the change in the position, the direction in which the second node is to be displayed.

### (Supplementary Note C1)

A display control program causing a computer to function as: a direction determination means that, in a case where at least one second node related to a first node is switched from a non-displayed state to a displayed state in a graph in which a relation between a plurality of elements is represented by nodes and an edge, determines a direction in which the second node is to be displayed relative to the first node; and a display control means that causes the second node to be displayed in the direction that has been determined by the direction determination means.

### (Supplementary Note C2)

The display control program according to supplementary note C1, wherein the direction determination means determines the direction in which the second node is to be displayed, on the basis of a position of the first node in a display area of the graph.

### (Supplementary Note C3)

The display control program according to supplementary note C2, wherein the direction determination means determines, as the direction in which the second node is to be displayed, a direction from the first node to an outer side of the display area.

### (Supplementary Note C4)

The display control program according to supplementary note C2 or C3, wherein the direction determination means determines, as the direction in which the second node is to be displayed, a direction assigned to a sectional area in which the first node is disposed among a plurality of sectional areas into which the display area is divided.

### (Supplementary Note C5)

The display control program according to supplementary note C4, causing the computer to function as a dividing means that sets the plurality of sectional areas by dividing the display area in accordance with the graph.

### (Supplementary Note C6)

The display control program according to any one of supplementary notes C1 to C5, wherein the direction determination means determines the direction in which the second node is to be displayed, on the basis of a position another node which is displayed in a surrounding area of the first node.

### (Supplementary Note C7)

The display control program according to supplementary note C6, wherein the direction determination means divides the surrounding area of the first node into a plurality of sectional surrounding areas, and determines the direction in which the second node is to be displayed, on the basis of the number of other nodes disposed in each of the sectional surrounding areas.

### (Supplementary Note C8)

The display control program according to any one of supplementary notes C1 to C7, causing the computer to function as a receiving means that receives an operation for changing a position of the first node, in a case where a change in the position of the first node is made while the second node is in the displayed state, the display control means changing, in accordance with the change in the position, the direction in which the second node is to be displayed.

### (Supplementary Note D1)

An information processing apparatus including at least one processor, the at least one processor carrying out: a direction determination process of, in a case where at least one second node related to a first node is switched from a non-displayed state to a displayed state in a graph in which a relation between a plurality of elements is represented by nodes and an edge, determining a direction in which the second node is to be displayed relative to the first node; and a display control process of causing the second node to be displayed in the direction that has been determined by the direction determination process.

### (Supplementary Note D2)

The information processing apparatus according to supplementary note D1, wherein in the direction determination process, the at least one processor determines the direction in which the second node is to be displayed, on the basis of a position of the first node in a display area of the graph.

### (Supplementary Note D3)

The information processing apparatus according to supplementary note D2, wherein in the direction determination process, the at least one processor determines, as the direction in which the second node is to be displayed, a direction from the first node to an outer side of the display area.

### (Supplementary Note D4)

The information processing apparatus according to supplementary note D2 or D3, wherein in the direction determination process, the at least one processor determines, as the direction in which the second node is to be displayed, a direction assigned to a sectional area in which the first node is disposed among a plurality of sectional areas into which the display area is divided.

### (Supplementary Note D5)

The information processing apparatus according to supplementary note D4, wherein the at least one processor carries out a division process of setting the plurality of sectional areas by dividing the display area in accordance with the graph.

### (Supplementary Note D6)

The information processing apparatus according to any one of supplementary notes D1 to D5, wherein in the direction determination process, the at least one processor determines the direction in which the second node is to be displayed, on the basis of a position of another node which is displayed in a surrounding area of the first node.

### (Supplementary Note D7)

The information processing apparatus according to supplementary note D6, wherein in the direction determination process, the at least one processor divides the surrounding area of the first node into a plurality of sectional surrounding areas, and determines the direction in which the second node is to be displayed, on the basis of the number of other nodes disposed in each of the sectional surrounding areas.

### (Supplementary Note D8)

The information processing apparatus according to any one of supplementary notes D1 to D7, wherein: the at least one processor carries out a reception process of receiving an operation for changing a position of the first node; and in a case where a change in the position of the first node is made while the second node is in the displayed state, the at least one processor changes, in accordance with the change in the position, the direction in which the second node is to be displayed.

### (Supplementary Note E)

A non-transitory storage medium in which a display control program is stored, the display control program causing a computer to carry out: a direction determination process of, in a case where at least one second node related to a first node is switched from a non-displayed state to a displayed state in a graph in which a relation between a plurality of elements is represented by nodes and an edge, determining a direction in which the second node is to be displayed relative to the first node; and a display control process of causing the second node to be displayed in the direction that has been determined by the direction determination process.

### REFERENCE SIGNS LIST

1 information processing apparatus
101 direction determination section (direction determination means)
102 display control section (display control means)
1A information processing apparatus
101A direction determination section (direction determination means)
102A display control section (display control means)
103A dividing section (dividing means)
104A receiving section (receiving means)
1B information processing apparatus
101B direction determination section (direction determination means)
102B display control section (display means)
104B receiving section (receiving means)

1. An information processing apparatus comprising at least one processor, the at least one processor carrying out:
a direction determination process of, in a case where at least one second node related to a first node is switched from a non-displayed state to a displayed state in a graph in which a relation between a plurality of elements is represented by nodes and an edge, determining a direction in which the second node is to be displayed relative to the first node; and
a display control process of causing the second node to be displayed in the direction that has been determined by the direction determination process.

2. The information processing apparatus according to claim 1, wherein in the direction determination process, the at least one processor determines the direction in which the second node is to be displayed, on the basis of a position of the first node in a display area of the graph.

3. The information processing apparatus according to claim 2, wherein in the direction determination process, the at least one processor determines, as the direction in which the second node is to be displayed, a direction from the first node to an outer side of the display area.

4. The information processing apparatus according to claim 2, wherein in the direction determination process, the at least one processor determines, as the direction in which the second node is to be displayed, a direction assigned to a sectional area in which the first node is disposed among a plurality of sectional areas into which the display area is divided.

5. The information processing apparatus according to claim 4, wherein the at least one processor carries out a division process of setting the plurality of sectional areas by dividing the display area in accordance with the graph.

6. The information processing apparatus according to claim 1, wherein in the direction determination process, the at least one processor determines the direction in which the second node is to be displayed, on the basis of a position of another node which is displayed in a surrounding area of the first node.

7. The information processing apparatus according to claim 6, wherein in the direction determination process, the at least one processor divides the surrounding area of the first node into a plurality of sectional surrounding areas, and determines the direction in which the second node is to be displayed, on the basis of the number of other nodes disposed in each of the sectional surrounding areas.

8. The information processing apparatus according to claim 1, wherein:
the at least one processor carries out a reception process of receiving an operation for changing a position of the first node; and
in a case where a change in the position of the first node is made while the second node is in the displayed state, the at least one processor changes, in accordance with the change in the position, the direction in which the second node is to be displayed.

9. A display control method comprising:
at least one processor carrying out a direction determination process of, in a case where at least one second node related to a first node is switched from a non-displayed state to a displayed state in a graph in which a relation between a plurality of elements is represented by nodes and an edge, determining a direction in which the second node is to be displayed relative to the first node; and
the at least one processor carrying out a display control process of causing the second node to be displayed in the direction that has been determined by the direction determination process.

10. A non-transitory, computer-readable storage medium in which a display control program is stored, the display control program causing a computer to function as:
a direction determination means that, in a case where at least one second node related to a first node is switched from a non-displayed state to a displayed state in a graph in which a relation between a plurality of elements is represented by nodes and an edge, determines a direction in which the second node is to be displayed relative to the first node; and
a display control means that causes the second node to be displayed in the direction that has been determined by the direction determination means.
